(19) United States
(12) Patent Application Publication
(10) Pub. No.: US 2005/0241672 A1
(43) Pub. Date: Nov. 3, 2005

(54) Extraction of impurities in a semiconductor process with a supercritical fluid

(75) Inventors: Phillip D. Matz, McKinney, TX (US); Sameer K. Ajmera, Richardson, TX (US); Ju-Ai Ruan, Plano, TX (US); Jinyoung Kim, McKinney, TX (US); Zhijian Lu, Plano, TX (US); Laura Matz, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/917,772

(22) Filed: Aug. 13, 2004

Related U.S. Application Data
(60) Provisional application No. 60/566,124, filed on Apr. 28, 2004.

(51) Int. Cl. B08B 6/00

(52) U.S. Cl. 134/1.2; 134/2; 134/166 R

(57) ABSTRACT

A method comprises extracting impurities from one or more materials in a semiconductor device via treatment with a supercritical fluid (SCF). The SCF may comprise a solvent and one or more co-solvents. Solvents may comprise 1-hexanol, 1-propanol, 2-propanol, acetone, ammonia, argon, carbon dioxide, chlorotrifluoromethane, cyclohexane, dichlorodifluoromethane, ethane, ethyl alcohol, ethylene, methane, methanol, n-butane, n-hexane, nitrous oxide, n-pentane, propane, propylene, toluene, trichlorofluoromethane, trichloromethane, water, or combinations thereof.

### CROSS-REFERENCE TO RELATED APPLICATIONS

The present application claims priority from U.S. Provisional Patent Application No. 60/566,124, filed on Apr. 28, 2004, which application is hereby incorporated by reference for all purposes.

### TECHNICAL FIELD

This application relates generally to semiconductor processing and in particular to extracting impurities from materials that make up a semiconductor device by treatment with a supercritical fluid.

### BACKGROUND

Integrated circuits are fabricated on the surface of a semiconductor wafer in layers, and later singulated into individual semiconductor devices, or “dies.” Many fabrication processes are repeated numerous times, constructing layer after layer until fabrication is complete. Metal layers, which typically increase in number as device complexity increases, include patterns of conductive material that are vertically insulated from one another by alternating layers of insulating, or dielectric material. Conductive traces are also separated within each layer by an insulating material. Vertical, conductive tunnels called “vias” typically pass through insulating layers to form conductive pathways between adjacent conductive patterns. The materials that make up the layers, patterns, and structures in a semiconductor device unfortunately contain impurities, either intrinsic or introduced during the manufacturing processes, that may diffuse through, or change the electrical properties of, the materials and cause defects in the device.

### SUMMARY

In at least some embodiments, a method comprises extracting impurities from one or more materials in a semiconductor device via treatment with a supercritical fluid (SCF). The SCF may comprise a solvent and one or more co-solvents. Solvents may comprise 1-hexanol, 1-propanol, 2-propanol, acetone, ammonia, argon, carbon dioxide, chlorotrifluoromethane, cyclohexane, dichlorodifluoromethane, ethane, ethyl alcohol, ethylene, methane, methanol, n-butane, n-hexane, nitrous oxide, n-pentane, propane, propylene, toluene, trichlorofluoromethane, trichloromethane, water, or combinations thereof. Co-solvents may comprise any suitable substance capable of increasing the ability of a SCF to extract one or more impurities from materials in a semiconductor device. In various embodiments, co-solvents may comprise acetone, an alcohol, water, acetonitrile, or combinations thereof.

In accordance with other embodiments, a system for extracting impurities from materials in a semiconductor device comprises a processing chamber and a die disposed with a fluid in the processing chamber at conditions effective for causing the fluid to persist as a SCF. The system may further comprise a staging chamber upstream of the processing chamber where conditions in the staging chamber cause the fluid to persist as a supercritical fluid prior to entering the processing chamber. Conditions in the processing chamber may comprise a temperature range from about 30 to about 300 degrees Celsius and a pressure range from about 500 to about 10,000 psi.

### BRIEF DESCRIPTION OF THE DRAWINGS

FIGS. 1a and 1b illustrate a cross-sectional view of materials in a semiconductor device in which impurities, such as byproducts of a chemical vapor deposition process, are deposited and extracted in accordance with a preferred embodiment of the invention.

FIGS. 2a and 2b illustrate another cross-sectional view of materials in a semiconductor device in which impurities, such as byproducts of an etch/ash/wet-clean sequence, are deposited and extracted in accordance with a preferred embodiment of the invention.

FIGS. 3a and 3b illustrate yet another cross-sectional view of materials in a semiconductor device in which impurities, such as resist-poisoning species, are extracted in accordance with a preferred embodiment of the invention.

FIG. 4 shows a process chamber in which impurities are extracted from one or more materials in a semiconductor device.

FIG. 5 illustrates an alternative embodiment comprising a staging chamber and a process chamber for extracting impurities from one or more materials in a semiconductor device.

### NOTATION AND NOMENCLATURE

Certain terms are used throughout the following description and claims to refer to particular components. As one skilled in the art will appreciate, companies may refer to a component by different names. This document does not intend to distinguish between components that differ in name but not function. Also employed throughout this document are the terms “including” and “comprising,” which are used in an open-ended fashion, and thus should be interpreted to mean “including, but not limited to . . . ”.

The term “integrated circuit” or “IC” refers to a set of electronic components and their interconnections (internal electrical circuit elements, collectively) that are patterned on the surface of a microchip. The term “semiconductor device” refers generically to an integrated circuit (IC). The term “die” (“dies” for plural) refers generically to an integrated circuit or semiconductor device, which may be a portion of a wafer, in various stages of completion, including the underlying semiconductor substrate, insulating materials, and all circuitry patterned thereon. The term “trench” refers generically to any feature that adds a dimension among the materials forming a die.

The term “supercritical fluid” (or “SCF”) refers to any fluid employed in its supercritical state. A substance is in its supercritical state when the substance is at or above its critical temperature and critical pressure, where it exhibits both liquid and gas-like properties. A supercritical fluid may comprise a single component, or “solvent,” or a mixture of a solvent and one or more co-solvents. If the SCF comprises a mixture, the term “solvent” refers to the component in the mixture that, under operating conditions (e.g., operating temperature and pressure), would remain in, or would be closest to, a supercritical fluid state if the other component(s) were not present.

### DETAILED DESCRIPTION OF EMBODIMENTS

Provided herein are methods of extracting impurities from one or more materials in a semiconductor device via treatment with a supercritical fluid. In accordance with the various embodiments described below, SCF extraction may be used to exploit the mobility, or diffusivity, of supercritical fluids within the materials employed in the construction of an integrated circuit (or “IC”). The SCF penetrates one or more materials forming the IC and acts as a solvent to dissolve and extract/remove impurities. The SCF acts as the solvent, and the impurity acts as a solute. A SCF may be employed at various stages of completion of an IC as impurities may be introduced by a variety of manufacturing processes. Treatment with a SCF thus removes a variety of, and at least some, impurities from one or more materials forming the IC.

The material(s) and impurity(ies) of concern at a particular stage of manufacture motivate selection of the appropriate SCF and processing conditions. Thus, the SCF extraction process may be tailored to particular materials and impurities. In various embodiments, the SCF may comprise a single component or a mixture of components. As a mixture, a SCF preferably comprises a solvent and one or more co-solvents. Treatment conditions, typically temperature, pressure, and process time, may be adjusted to ensure that the fluid maintains the characteristics of a SCF.

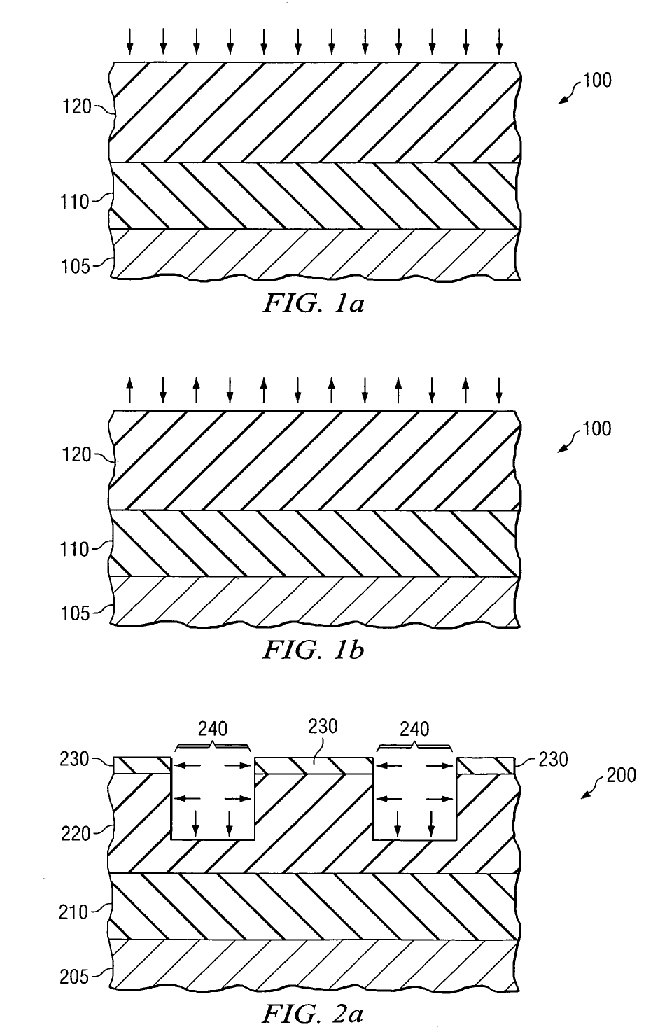

FIGS. 1a and 1b illustrate cross-sectional views of various materials in a semiconductor device. The views are of a semiconductor structure 100, e.g., a die, die sample, or portion of a wafer, at an intermediate step in the construction of an IC. A layer 105 of copper is adjacent an etch-stop dielectric material 110. A layer 120 of low-k dielectric material is deposited via plasma enhanced chemical vapor deposition (PECVD) to adjoin the etch-stop dielectric material 110. FIG. 1a illustrates the PECVD process. Impurities accompany the material deposited via PECVD. The impurities are mobile in the low-k dielectric layer 120, etch stop dielectric layer 110, and metal layer 105. FIG. 1b illustrates a treatment of the structure 100 with a supercritical fluid. The fluid diffuses into one or more layers of material 120, 110, and 105 in order to act as a solvent and extract the embedded impurities.

Supercritical fluids as described herein may comprise any substance capable of achieving a supercritical state and extracting impurities from materials that make up a semiconductor device. In at least one embodiment, the supercritical fluid comprises one component. In other embodiments, the supercritical fluid comprises a solvent and one or more co-solvents. Depending on the particular extraction application, the same substance may be employed as any of a single-component SCF, a solvent in a multi-component SCF, or a co-solvent in a multi-component SCF. Examples of such substances comprise 1-hexanol, 1-propanol, 2-propanol, acetone, ammonia, argon, carbon dioxide, chlorotrifluoromethane, cyclohexane, dichlorodifluoromethane, ethane, ethyl alcohol, ethylene, methane, methanol, n-butane, n-hexane, nitrous oxide, n-pentane, propane, propylene, toluene, trichlorofluoromethane, trichloromethane, water, or combinations thereof.

A multi-component SCF may be a mixture comprising a solvent and one or more co-solvents. In an embodiment, a co-solvent comprises any substance that increases the ability of a SCF to extract one or more impurities. Examples of co-solvents include, but are not limited to, acetone, methanol, ethanol, propanol, butanol, water, acetonitrile, or combinations thereof. A multi-component SCF may comprise, for example, carbon dioxide as the solvent and an alcohol as the co-solvent; alternatively, a SCF may comprise carbon dioxide as the solvent, water as a co-solvent, and an alcohol as another co-solvent. In specific embodiments, a SCF as used herein may comprise from about 0 to about 10 volume percent water, from about 20 to about 40 volume percent ethanol, and from about 60 to about 80 volume percent carbon dioxide. Alternatively, the SCF may comprise from about 70 to about 99 volume percent carbon dioxide, with most or all of the remainder (from about 1 to about 30 volume percent) comprising methanol.

The selection of a single or multi-component supercritical fluid, and the particular components that make up the supercritical fluid, may be motivated by, among other things, the types of impurities intended for extraction, and type of material(s) from which the extraction will occur. Among other considerations, adjusting the types and amounts of co-solvents may control (e.g., increase) the dissolution rate of impurities. Optimizing the extraction process may involve attention to the balance between dissolution rate, which may reduce process time, and total operating costs, including material costs.

For purposes of extraction, both SCFs and impurities may be categorized as polar, non-polar, or ionic. The terms “polar”, “non-polar”, and “ionic” are used herein as they would be used by one skilled in the art. Generally, a non-polar SCF extracts non-polar impurities, and a polar SCF extracts polar and/or ionic impurities. The polarity of an SCF may be modified to accommodate extraction of any or all of polar, non-polar, and ionic impurities. For example, carbon dioxide is typically a non-polar SCF, which may be employed to extract non-polar species, such as hydrocarbons. An alcohol, which is polar and will typically form a polar SCF, such as ethyl alcohol, may be added as a co-solvent to the carbon dioxide (i.e., solvent) to modify the polarity of the SCF. The ethyl alcohol co-solvent provides some polarity to the SCF comprising primarily carbon dioxide. The mixture of carbon dioxide and ethyl alcohol may be employed as an SCF to extract both polar and non-polar species. The percentage of co-solvent in the mixture determines the resulting polarity of the mixture. Thus, the polarity of the SCF may be adjusted for removal of different types of impurities in the same operation: polar, non-polar, or ionic. Multiple co-solvents may be added to address a range of impurities.

Impurities may comprise various mobile contaminants introduced to a semiconductor device via a semiconductor manufacturing process. Impurities may be contributed to the IC from any number of sources in the manufacturing line. Examples of specific processes known to expose a die to impurities comprise plasma processes, etching, ashing, CMP, and cleaning processes. Considerations for optimizing impurity extraction from an IC with a SCF comprise material density and thickness; whether the impurity is polar, non-polar, or ionic; concentration gradient of the impurity within the material(s); and mobility of the impurity species. Examples of non-polar species comprise hydrocarbons, methane, ethane, toluene, and hydrogen. Examples of polar species comprise water, alcohols, and amines. Examples of ionic species comprise fluoride and sodium.

The materials from which impurities may be extracted comprise materials employed in fabricating a semiconductor device or die. Material density affects the mobility of impurities, the mobility of a SCF, and, thus, the ability of the SCF to extract the impurities. Process conditions, such as process time, may be modified depending upon material density. In addition, extraction may be executed among one or more layers of material where the densities of the materials vary. For example, the impurities of interest may be more prominent in a less dense layer of material, where a material of a greater density separates the less dense layer from contact with the SCF. In such a case, process conditions, such as time, temperature, and pressure, may be adjusted to allow the SCF to diffuse through the separating material and extract the impurities from the sub-layer. Material density may also affect selection of an SCF, as the diffusivity of various SCFs may be optimized for more or less dense materials. Relevant materials may comprise dielectric materials. Alternatively, the materials may comprise doped and undoped silicon and silicon dioxide; silicon nitride; silicon carbide; carbon doped silicon oxide; methylsilsesquioxane based dielectrics; or combinations thereof.

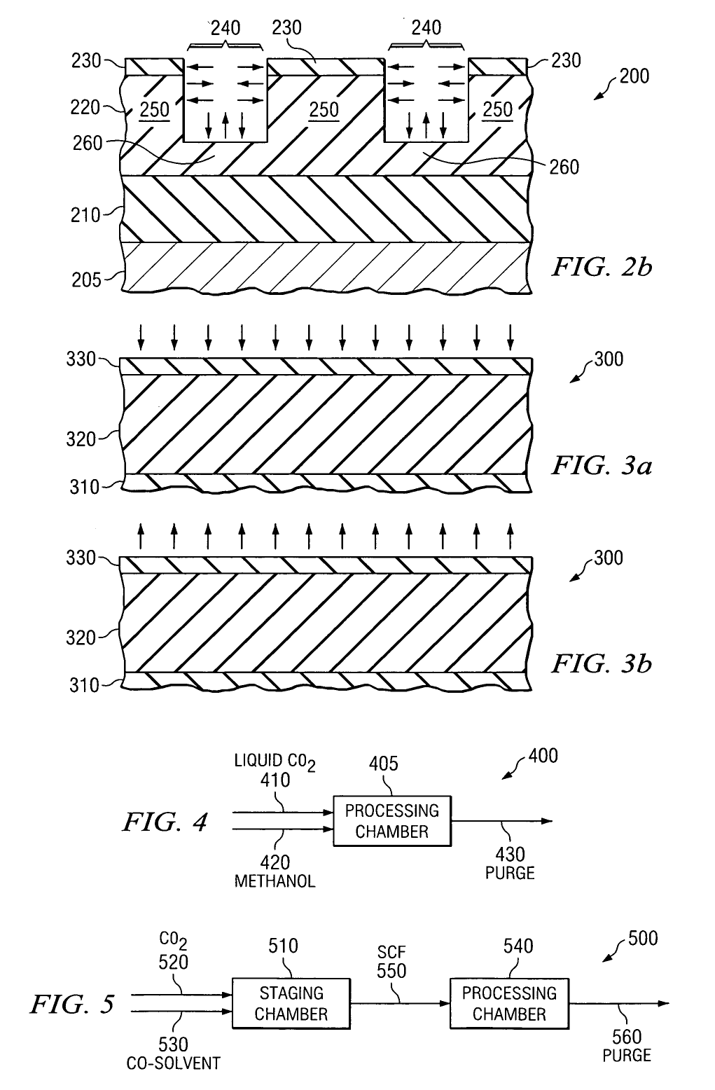

FIGS. 2a and 2b illustrate a cross-sectional view of materials in a semiconductor device. The view shown is of a semiconductor structure 200 at an intermediate step in the construction of an IC. Trench formations 240, such as those typically employed in the fabrication of IC interconnects, interrupt the surface of the structure 200. A cap dielectric layer 230 and a low-k dielectric layer 220 are adjacent to an etch-stop layer 210 and copper layer 205. FIG. 2a illustrates the action of impurities, e.g., fluoride and oxide ions, introduced by the etch step, and also by subsequent ash and wet-cleaning steps, as the impurities diffuse into the dielectric layer or layers. FIG. 2b illustrates an embodiment of a treatment with a SCF comprising about 95 volume percent carbon dioxide and about 5 volume percent methanol. Whereas a carbon dioxide SCF is typically employed as a non-polar solvent to extract non-polar impurities, the 5 volume percent methanol adjusts the polarity of the SCF to facilitate the SCF's ability to extract polar and ionic species. The SCF diffuses into the layers of material to act as a solvent to extract the impurities, where the impurities act as the solute. Such a treatment may be employed to reduce leakage currents. The extraction may occur from areas 250, 260 between or below the trench formations 240.

FIGS. 3a and 3b illustrate an alternative embodiment of a method for extracting impurities from materials in a semiconductor device 300 via a SCF in order to prevent resist poisoning. A layer of dielectric material 320, such as Novellus's low-k Coral dielectric, adjoins the silicon substrate 310. FIG. 3a illustrates the action of amines that may enter a structure 300 during the course of semiconductor fabrication from any number of sources. Examples of such sources include typical IC fabrication processes, such as plasma processes, etching, ashing, chemical-mechanical polishing (CMP), and cleaning processes. The diffusion of such amines to the surface 330 of the structure 300 may cause resist poisoning, which typically leads to defects and, thus, scrapping of product. FIG. 3b illustrates the action of a SCF to extract amines from the structure 300. In this embodiment the SCF comprises about 30 volume percent ethanol, about 3 volume percent water, and about 67 volume percent carbon dioxide. By extracting the amines from the materials, the SCF reduces the probability that resist poisoning may occur.

Temperatures and pressures suitable for the preferred method provided may vary. The temperature and pressure may be adjusted as needed to maintain the characteristics of a supercritical fluid. Other considerations when adjusting temperature and pressure comprise SCF and impurity diffusivity and polarity. An appropriate temperature range may be in the range from about 30 to about 300 degrees Celsius. Appropriate pressures may comprise a range of from about 500 to about 10,000 psi.

The level of penetration and extraction achieved by the methods provided herein may be time-dependent. Longer treatment times generally result in deeper penetration of the SCF and greater extraction of impurities. Examples of factors that may influence treatment time include the type/density, thickness, and number of material layers from which it is desirable to remove impurities; and the forecasted time delay between the SCF treatment step and subsequent steps that may be sensitive to the impurities intended for extraction. In some embodiments, the process of extraction of impurities is executed for an effective amount of time. The amount of time may be from about 15 seconds to about 3 hours. In some embodiments, the time may be from about 20 seconds to about 1.5 hours and further still from about 30 seconds to about 15 minutes.

FIG. 4 illustrates an embodiment of a system 400 for extracting impurities from one or more materials in a semiconductor device. The semiconductor structure 100 of FIGS. 1a and 1b is placed in a processing chamber 405. The processing chamber 405 is capable of containing a die sample, die, wafer, or multiple wafers and maintaining a processing environment for SCF extractions. Liquid carbon dioxide is supplied to the chamber 405 through the inlet 410. Methanol is also delivered to the chamber 405 via inlet 420. The mixture of carbon dioxide and methanol in the chamber 405 may comprise about five volume percent methanol. Chamber 405 operating conditions may include a temperature of about 60 degrees Celsius, and a pressure of about 2900 psi, such that the mixture persists as a supercritical fluid. The SCF extracts impurities from the structure 100. The used SCF and dissolved impurities are then purged from the processing chamber 405 through an outlet 430. In some embodiments, the extraction process may be repeated one or more times in order to optimize extraction of impurities, process time, and operating costs.

If desired, the SCF may be employed to purge water from the processing chamber 405 prior to treating the semiconductor structure 100. The water and SCF may be purged prior to extraction via outlet 430, or, alternatively, via a purge outlet 440.

In an embodiment illustrated by FIG. 5, the SCF component, e.g., carbon dioxide, enters a staging chamber 510 via a supply line 520. An inlet 530 supplies a co-solvent, e.g., methanol, to the staging chamber 510. In an embodiment, the carbon dioxide and methanol mix and are subjected to conditions such that a supercritical fluid is achieved in the staging chamber 510. A process feed line 550 supplies the two-component SCF to the processing chamber 540. After executing the extraction of impurities from the semiconductor structure 100, the SCF comprising carbon dioxide and methanol, along with extracted impurities, is purged from the process chamber 540 via a purge line 560. In various embodiments dictated by the impurities of concern at a particular stage of manufacture, more than one co-solvent may be supplied either directly to the processing chamber 540, or to the staging chamber 510, to achieve an appropriate SCF for extraction. Additionally, the necessary temperature and pressure for the SCF may be accomplished for the first time in the staging chamber 510, processing chamber 540, or supply line 550.

Impurities are problems throughout the course of semiconductor fabrication. It may be recognized by those skilled in the art that the methods provided herein are applicable at any number of points in the flow of semiconductor fabrication, including front end of line and back end of line processes.

Examples of the many advantages of the method provided comprise: improvement of low-power battery performance and high-power heat generation; decreased leakage current; increased dielectric breakdown strength; allowance of reworks subsequent to lithographic errors; reduction in dielectric and barrier layer thicknesses; elimination of processing steps; increased time-dependent dielectric breakdown; a lower thermal budget; and reduced resist poisoning.

While various embodiments of the invention have been shown and described, modifications thereof can be made by one skilled in the art without departing from the spirit and teachings of the invention. The embodiments described herein are exemplary only, and are not intended to be limiting. Equivalent techniques and ingredients may be substituted for those shown, and other changes can be made within the scope of the present invention as defined by the appended claims. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

1. A method, comprising:
applying a supercritical fluid (SCF) to a material in a semiconductor device; and
extracting impurities from the material via the supercritical fluid (SCF).

2. The method of claim 1 wherein applying the SCF comprises applying 1-hexanol, 1-propanol, 2-propanol, acetone, ammonia, argon, carbon dioxide, chlorotrifluoromethane, cyclohexane, dichlorodifluoromethane, ethane, ethyl alcohol, ethylene, methane, methanol, n-butane, n-hexane, nitrous oxide, n-pentane, propane, propylene, toluene, trichlorofluoromethane, trichloromethane, water, or combinations thereof.

3. The method of claim 1 further comprising combining a solvent and one or more co-solvents to form a SCF;
wherein a co-solvent comprises a substance capable of increasing the ability of a SCF to extract one or more impurities.

4. The method of claim 3 wherein combining a solvent and one or more co-solvents comprises combining a solvent and acetone, an alcohol, water, acetonitrile, or combinations thereof.

5. The method of claim 3 wherein combining a solvent and one or more co-solvents comprises combining a solvent and methanol, ethanol, propanol, butanol, or combinations thereof.

6. The method of claim 1 wherein extracting impurities comprises extracting hydrocarbons, methane, ethane, toluene, hydrogen, water, alcohols, amines, fluoride, sodium, or combinations thereof.

7. The method of claim 1 wherein the material comprises a dielectric material.

8. The method of claim 1 wherein the material comprises doped and undoped silicon and silicon dioxide; silicon nitride; silicon carbide; carbon doped silicon oxide; methylsilsesquioxane based dielectrics; or combinations thereof.

9. The method of claim 1 wherein the SCF comprises carbon dioxide as the solvent and an alcohol as the co-solvent.

10. The method of claim 1 wherein the SCF comprises carbon dioxide as the solvent, water as a co-solvent, and an alcohol as another co-solvent.

11. The method of claim 1 wherein the SCF comprises from about 70 to about 99 volume percent carbon dioxide and from about 1 to about 30 volume percent methanol.

12. The method of claim 1 wherein the SCF comprises from about 0 to about 10 volume percent water, from about 20 to about 40 volume percent ethanol, and from about 60 to about 80 volume percent carbon dioxide.

13. A system for extracting impurities from materials in a semiconductor device, comprising:
a processing chamber; and
a die exposed to a fluid in the processing chamber at conditions effective for causing the fluid to persist as a SCF;
wherein the SCF extracts impurities from the die.

14. The system of claim 13 further comprising a staging chamber upstream of the processing chamber wherein conditions in the staging chamber cause the fluid to persist as a supercritical fluid prior to entering the processing chamber.

15. The system of claim 13 wherein conditions comprise a temperature range from about 30 to about 300 degrees Celsius.

16. The system of claim 13 wherein conditions comprise a pressure range from about 500 to about 10,000 psi.

17. The system of claim 13 wherein conditions comprise a processing time from about 15 seconds to about 30 hours.
